(19) United States
(12) Patent Application Publication
(10) Pub. No.: US 2010/0239100 A1
(43) Pub. Date: Sep. 23, 2010

(54) METHOD FOR ADJUSTING A DIRECTIONAL CHARACTERISTIC AND A HEARING APPARATUS

(75) Inventor: Andre Steinbuss, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/727,443

(22) Filed: Mar. 19, 2010

(30) Foreign Application Priority Data
Mar. 19, 2009 (DE) 10 2009 014 053.0

(51) Int. Cl. H04R 29/00; H04R 25/00

(52) U.S. Cl. 381/60; 381/313; 381/92

(57) ABSTRACT

The aim is to improve the adjustment of the directional characteristic of a hearing apparatus, and in particular of a hearing aid. A method is therefore provided in which a microphone signal having a plurality of frequency bands is derived from an input sound being obtained by a microphone system containing at least two microphones. A characteristic of the microphone signal is then determined, for example the level. The directional characteristic of the microphone system is adjusted in dependence on the determined characteristic of the microphone signal. In order to adjust the directional characteristic, two or more frequency bands are combined in dependence on the determined characteristic of the microphone signal. Alternatively, one of the microphones can also be attenuated, thus deliberately reducing the directionality of the directional microphone.

### CROSS-REFERENCE TO RELATED APPLICATION

This application claims the priority, under 35 U.S.C. §119, of German application DE 10 2009 014 053.0, filed Mar. 19, 2009; the prior application is herewith incorporated by reference in its entirety.

### BACKGROUND OF THE INVENTION

### Field of the Invention

The present invention relates to a method for adjusting a directional characteristic of a hearing apparatus by obtaining a microphone signal which has a plurality of frequency bands from an input sound by a microphone system containing at least two microphones. A characteristic of the microphone signal is determined and the directional characteristic of the microphone system is adjusted in dependence on the determined characteristic of the microphone signal. The present invention furthermore relates to a corresponding hearing apparatus. In this case, a hearing apparatus refers to any sound-emitting appliance which can be worn on the ear or on the head, in particular a hearing aid, a headset, earphones and the like.

Hearing aids are portable hearing apparatuses which are used for assisting the deaf. In order to comply with the numerous individual requirements, different forms of hearing aids are provided, such as behind-the-ear hearing aids, a hearing aid with an external receiver (RIC: receiver in the canal) and in-the-ear hearing aids, for example also concha hearing aids or canal hearing aids.(ITE, CIC). The hearing aids mentioned by way of example are worn on the outer ear or in the auditory canal. Furthermore, however, bone conduction hearing aids, implantable or vibrotactile hearing aids are also commercially available. In this case, the damaged hearing is stimulated either mechanically or electrically.

In principle, the major components of hearing aids are an input transducer, an amplifier and an output transducer. The input transducer is generally a sound receiver, for example a microphone, and/or an electromagnetic receiver, for example an induction coil. The output transducer is generally an electro-acoustic transducer, for example a miniature loudspeaker, or an electromechanical transducer, for example a bone conduction receiver. The amplifier is normally integrated in a signal processing unit. This basic configuration is illustrated in FIG. 1 using the example of a behind-the-ear hearing aid. One or more microphones 2 for receiving the sound from the surrounding area are installed in a hearing aid housing 1 to be worn behind the ear. A signal processing unit 3, which is likewise integrated in the hearing aid housing 1, processes the microphone signals, and amplifies them. The output signal from the signal processing unit 3 is passed to a loudspeaker or receiver 4, which emits an acoustic signal. If appropriate, the sound is transmitted to the eardrum of the hearing aid wearer, possibly via a flexible sound tube which is fixed to an otoplasty in the auditory canal. The power supply for the hearing aid and in particular that for the signal processing unit 3 is provided by a battery 5, which is likewise integrated in the hearing aid housing 1.

International patent disclosure WO 2007/096247 A1 discloses a hearing aid in which it is possible to switch smoothly backwards and forwards between two operating modes. An omnidirectional signal and a directional signal are in each case formed in each channel of the output signal of a microphone system. The omnidirectional signal and the directional signal are mixed as a function of the signal level of the microphone signal.

Furthermore U.S. patent publication No. 2001/0038699 A1 discloses automatic directional control for a multi-microphone system. The activation and deactivation of the directional processing are controlled as a function of disturbances.

German patent DE 103 34 396 B3, corresponding to U.S. patent publication No. 2005/0058312, discloses a hearing aid having a directional microphone system including at least three microphones. A plurality of microphones is in each case connected to form microphone units, with the order of the directional characteristic of these microphone units in each case matching. Finally, the microphone signals from these microphone units are added, such that the order of the directional characteristic of the resultant microphone system also corresponds to the order of the directional characteristic of the individual microphone units.

Furthermore, German patent DE 103 31 956 B3, corresponding to U.S. Pat. No. 7,209,568, discloses a hearing aid in which the various directional characteristics are adjustable. The directional effect is increased in the event of a level increase, by varying the delay times.

European patent application EP 1 489 882 A2 describes a method of operating a hearing aid, in which microphone signals from microphone units with a different directional effect are weighted as a function of a signal level of the microphone signals. Following the different weighting of the microphone signals of the directional microphones in the individual frequency bands, the output signals from the amplifiers are first of all added within the frequency bands. The different weighting of the microphone signals from the directional microphones in the individual frequency bands results in optimization of the directional characteristic in the individual frequency bands.

Published, non-prosecuted German patent application DE 103 27 890 A1, corresponding to U.S. Pat. No. 7,340,073, describes a method for operation of a hearing aid in which a microphone signal from an omnidirectional microphone and a microphone signal from a microphone unit with a directional effect are weighted and added for individual frequency bands. The weighting results in the signal levels of the microphone signals in the individual frequency bands being balanced. The method makes it possible to switch between microphone units with different directional characteristics and/or to superimpose them, in individual frequency bands.

Modern hearing aids have power directional microphones which in many cases are adaptive and have a plurality of channels. In addition, directional microphones can be activated and deactivated by situation identification algorithms. Overall, the complex directional microphone in modern hearing aids therefore leads to effective shadowing of interference sources at the rear and to a sharply matched lobe in the forward direction. Recently, however, hearing aid wearers have repeatedly reported that the directional effect is too strong and that the sensitivity from the side is already too weak in a noisy environment, and that orientation and localization are interfered with.

### SUMMARY OF THE INVENTION

It is accordingly an object of the invention to provide a method for adjusting a directional characteristic and a hearing apparatus which overcome the above-mentioned disadvantages of the prior art methods and devices of this general type, which improves the adjustment of the directional characteristic of the hearing apparatus.

According to the invention, the object is achieved by a method for adjusting a directional characteristic of a hearing apparatus by obtaining a microphone signal, which has a plurality of frequency bands from an input sound by a microphone system containing at least two microphones. A characteristic of the microphone signal is determined and the directional characteristic of the microphone system is adjusted in dependence on the determined characteristic of the microphone signal. In order to adjust the directional characteristic, two or more frequency bands are combined in dependence on the determined characteristic of the microphone signal in order to form a broader frequency band, and a common directional characteristic is in this way provided for the combined frequency bands, which common directional characteristic is slurred in comparison to directional characteristics for the two or more frequency bands, such that the directivity of the common directional characteristic is reduced.

Furthermore, according to the invention, a hearing apparatus is provided having a microphone system containing at least two microphones for obtaining a microphone signal which has a plurality of frequency bands, from an input sound. An analysis device is provided for determining a characteristic of the microphone signal. A processing device is provided for adjusting the directional characteristic of the microphone system in dependence on the determined characteristic of the microphone signal. While the directional characteristic is being adjusted, the processing device can combine two or more frequency bands in dependence on the determined characteristic of the microphone signal to form a broader frequency band, and can in this way provide a common directional characteristic for the combined frequency bands, which common directional characteristic is slurred in comparison to directional characteristics for the two or more frequency bands, such that the directivity of the common directional characteristic is reduced.

It is therefore advantageously possible to deliberately make the directionality of a microphone system worse, as a function of the environment switch. In certain hearing situations, this reduction in the directionality results in a directionality which in fact corresponds to the natural sound perception and assists the localization capability.

The characteristic of the microphone signal which is determined preferably contains the microphone signal level. Therefore the directional characteristic can be adjusted in dependence on the microphone signal level. In this case, it is particularly advantageous to increase the directionality of the microphone system as the level rises. When the level is very low, a directional microphone is then offered with only one very broad channel.

The characteristic of the microphone signal can possibly also characterize one of a plurality of predetermined acoustic situations. The directionality of the microphone system can therefore be controlled as a function of a predefined complex acoustic situation, for example “speech in the presence of interference noise”.

According to one development of the invention, it is possible to manually vary the number of bands, and the current number is learnt, together with the current characteristic of the microphone signal, for later automatic adjustment by the hearing apparatus. The slurring of the directional characteristics which are optimum for the individual frequency bands is thus stored for the individual hearing situations in the hearing apparatus and can then be adjusted automatically when a hearing situation such as this is identified again.

It is optionally possible to change from a static operating mode to an adaptive operating mode. Perceptively, this would also contribute to achieving the abovementioned aim since a static directional microphone attenuates sounds from the rearward half-plane only moderately in quiet environments. In contrast, an adaptive directional microphone would be perceived as being considerably more powerful in loud environments.

The abovementioned object, of achieving better adjustment of the directional characteristic, is also achieved according to the invention by a method for adjusting a directional characteristic of a hearing apparatus by obtaining a microphone signal from an input sound by a microphone system which has at least two microphones; and by determining a characteristic of the microphone signal and adjusting the directional characteristic of the microphone system in dependence on the determined characteristic of the microphone signal. In order to adjust the directional characteristic, one of the two microphones is attenuated in dependence on the determined characteristic of the microphone signal, or both microphones are mismatched to one another in dependence on the determined characteristic of the microphone signal such that the directivity of the directional characteristic is in this way reduced.

Furthermore, a hearing apparatus is also provided in this case, having a microphone system which has at least two microphones for obtaining a microphone signal from an input sound. An analysis device is provided for determining a characteristic of the microphone signal, and a processing device adjusts the directional characteristic of the microphone system in dependence on the determined characteristic of the microphone signal. While adjusting the directional characteristic, the processing device can attenuate one of the two microphones in dependence on the determined characteristic of the microphone signal, or both microphones are mismatched to one another as a function of the determined characteristic of the microphone signal, so as to reduce the directivity of the directional characteristic.

In addition, it is advantageously possible with this method and this hearing apparatus to deliberately make the directionality worse as a function of a hearing situation, specifically by attenuating one of a plurality of microphone signals. The attenuation automatically reduces the directional characteristic of the microphone system. The same effect of the reduction in the directionality can be achieved by deliberately mismatching the microphones with respect to one another. By way of example, this can be achieved by shifting the phase of the microphone signal.

In one specific embodiment, the attenuation or mismatching can be carried out as a function of an instantaneous gain of the hearing apparatus. There is then no need to specifically determine a characteristic directly of the microphone signal in order to adjust the directional characteristic, and to appropriately vary the directional characteristic. In fact, the gain can be used as a starting point for adjustment of the directional characteristic, which gain indirectly reflects the level of the microphone signal via the implemented gain characteristic of the hearing apparatus.

If the microphone system has a front microphone and a rear microphone when the hearing apparatus is worn in a predetermined position, it is advantageous to attenuate the rear microphone in order to reduce the directionality. This results in a frontal alignment of the directional characteristic in fact being maintained in comparison to the situation in which a front or a center microphone is attenuated.

Other features which are considered as characteristic for the invention are set forth in the appended claims.

Although the invention is illustrated and described herein as embodied in a method for adjusting a directional characteristic and a hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of an outline configuration of a hearing aid according to the prior art;

FIG. 2 is a circuit diagram sketch of a signal processing unit of a hearing aid according to the invention;

FIG. 3 is a graph showing a dependency of an articulation index-directivity index on the level;

FIG. 4 is a directional diagram for combined frequency channels; and

FIG. 5 is a graph showing a dependency of a number of combined channels from the level.

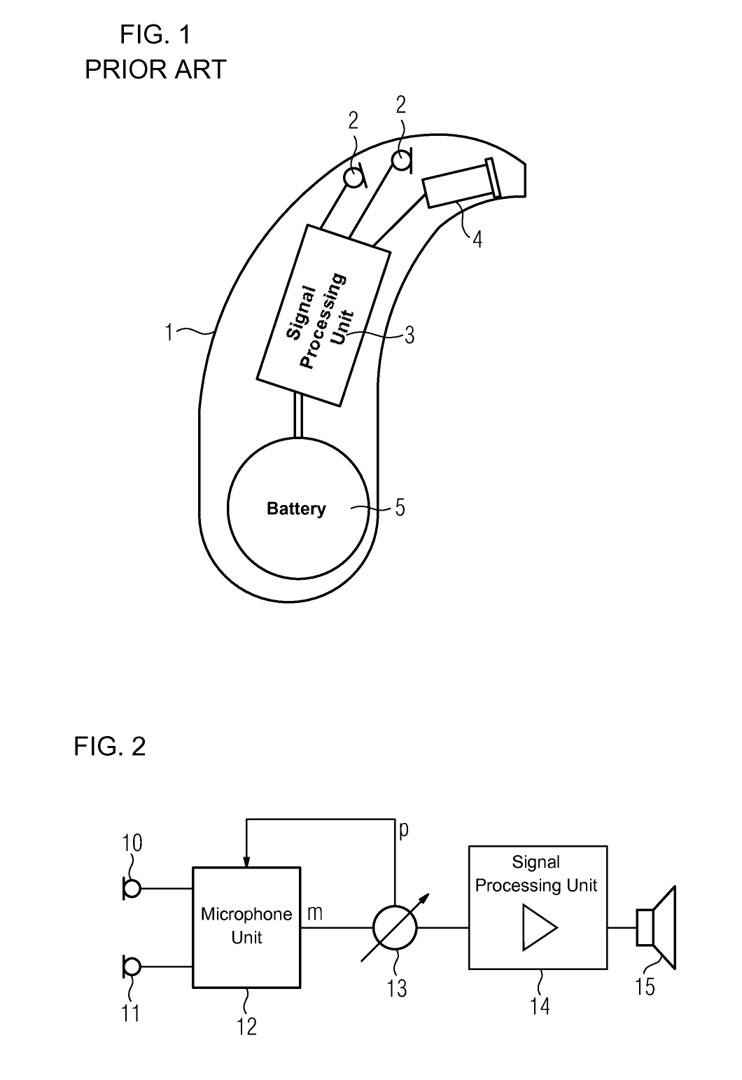

### DETAILED DESCRIPTION OF THE INVENTION

The exemplary embodiments described in more detail in the following text represent preferred embodiments of the present invention.

The idea according to the invention is that the effect of the directional microphone is slurred, that is to say artificially made worse. The slurring is carried out adaptively as a function of the acoustic environment or else as a function of personal preference. Level criteria, or else the result of any desired fine situation identification can be used, for example, as features or characteristics of the acoustic environment. The personal preference may, for example, be applied by the indirect hearing aid wearer via a control element. If required, the manually selected setting is stored in the hearing apparatus or in the hearing aid, together with the signal level and/or the situation identification, that is to say it can be learnt. After a learning phase, the slurring which has been learnt can be carried out within the respectively learnt extent in the presence of a specific hearing situation and/or a specific level.

The fundamental idea according to the invention may, for example be technically implemented in a hearing aid having the circuit components shown in FIG. 2. The microphones 10 and 11 (there may also be more than two microphones) each produce a signal which is supplied to a microphone unit 12. The microphone unit 12 processes the signals to form a resultant microphone signal m. The processing can be carried in parallel in a plurality of frequency bands. The microphones 10 and 11 are interconnected in the microphone unit 12, depending on the requirement, to form an omnidirectional microphone or a directional microphone with variable directionality.

The output signal m from the microphone unit 12 is supplied to a level meter 13. The level meter 13 symbolizes any analysis unit which analyzes the microphone signal m and/or the hearing situation on which it is based. The signal level p of the level meter 13 and/or an appropriate hearing situation identification is supplied back to the microphone unit 12. The directionality is then varied as required up to omnidirectionality, as a function of the level and the situation identification.

The microphone signal m is then subjected to conventional signal processing in a processing unit 14. Finally, the output signal from the signal processing unit 14 is converted to sound via a receiver 15.

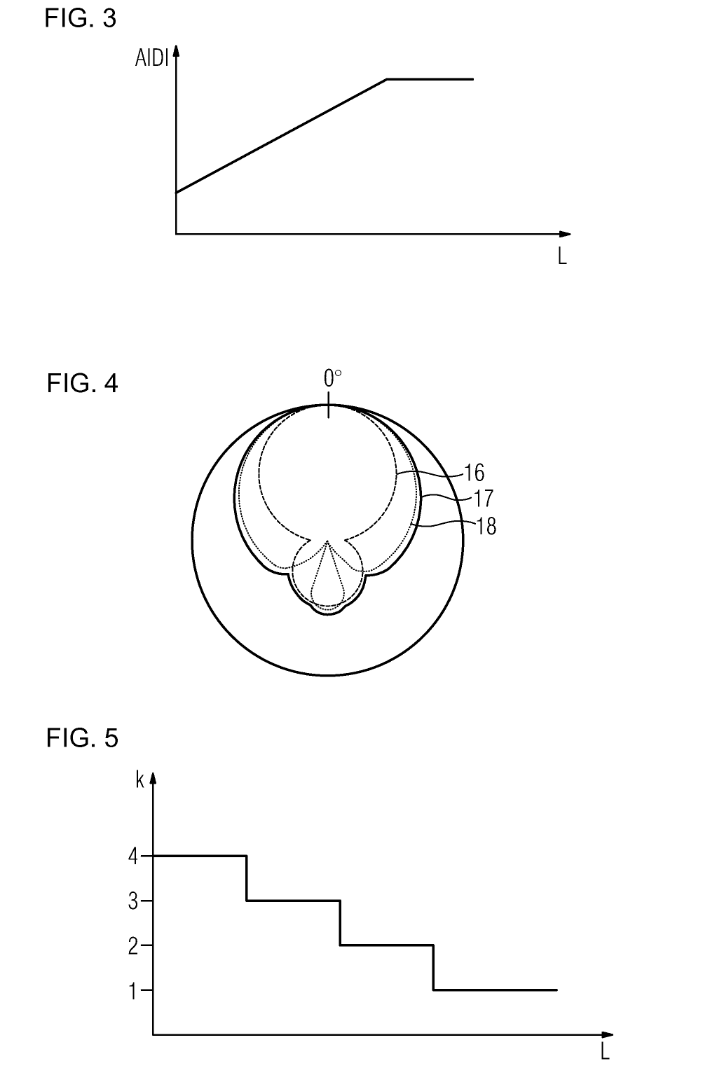

FIG. 3 indicates what effects the microphone unit 12 in FIG. 2, for example, may have. In principle, the aim here is to readjust the directionality measured for example by the articulation index directivity index (AIDI) as a function of the input level. The aim in particular is to provide low directivity at low levels and a correspondingly higher directivity at high levels. According to the present example shown in FIG. 3, the value AIDI therefore rises initially linearly starting from an initial value, until it reaches a maximum level, at which it remains. This characteristic may be stored in this or a similar manner in the microphone unit, in order to adjust the directional characteristic.

In particular, the two following options are available for influencing the directional characteristic of a microphone system, and in particular for making its directivity deliberately worse. On the one hand, it is possible to attenuate the microphone signal from that microphone which is arranged further to the rear, with respect to the back-front direction of the user, when the hearing apparatus is being worn. One of the two microphones 10 or 11 is therefore deliberately attenuated. Alternatively, the two microphones can also be mismatched with one another, that is to say an artificial mismatch is created between the frontward microphone and the rearward microphone. This effectively leads to less attenuation of rearward sound, because the directional effect decreases with the attenuation and/or the mismatch. The attenuation and/or the mismatch are/is then appropriately adaptively readjusted for adaptation to the environment, and the hearing aid offers more directionality as the level rises.

In the case of the described adaptation, it is necessary, for example, to measure the level of the input signal, that is to say the microphone signal. In order to avoid a specific measurement device for this purpose, the microphone at the rear can also be attenuated as a function of the applied gain. This is because the gain is an indirect measure of the input signal level. By way of example, the directionality can thus be reduced for high gain levels (which are produced when the input signals are quiet), because of the non-linear processing in hearing aids.

The combination of microphone channels or frequency channels can be considered to be a further measure for deliberately reducing the effect of a directional microphone. To do this, it is first of all necessary to know the method of operation of a specific directional microphone type. This directional microphone type is distinguished in that the directional characteristic is adjusted separately in the individual frequency bands. The adjustment is carried out by minimizing the level of the most dominant interference source in the rear half-plane. The respectively most dominant interference source is therefore masked out in each frequency band. However, in some circumstances, this may result in an excessive and undesirable directional effect. According to the invention, the directional effect is therefore reduced using the second method. This method consists in that a plurality of frequency bands are combined before finding the most dominant interference source depending on the level or hearing situation. This combination process is illustrated by way of example in FIG. 4, using two channels. The directional characteristic 16 (dashed line) with major notches (constrictions) in the 90° and 270° directions is obtained on a directional diagram for a first channel, for example at 500 Hz. A differential directional characteristic 17 (dashed line) is obtained in a second frequency band, for example around 1000 Hz. The notches in this directional characteristic 17 are directed further to the rear. If the signals in the two frequency bands are now added, then the two directional characteristics are slurred to form a common directional characteristic 18 (solid line). The common directional characteristic 18 has notches which are considerably less pronounced and the directional effect is correspondingly reduced. With regard to the outline sketch shown in FIG. 4, it should be noted that this indicates only symbolically how the directional characteristics can vary by the combination of frequency bands. It likewise illustrates the principle that directionality which is reduced overall results from the combination of the microphone channels or the frequency bands.

The frequency bands can be combined as a function of a desired criterion. This criterion may once again relate to a characteristic of the microphone signal. For example, the directionality may depend on a determined hearing situation. Alternatively, the directionality may also be adapted as a function of the level. In particular, the directionality can be made sharper as the environmental level rises. This is achieved as shown in FIG. 5 by the number k of combined frequency bands or channels decreasing with the level. In the present example four bands are combined at low levels, while only 3 or 2 are combined at medium levels, and only one channel is used for the directionality at higher levels. Therefore the directional effect is slurred to a greater extent for low levels than for high levels. For the hearing aid wearer, the features mentioned above result in the advantage that it is possible to profit from the full performance of a directional microphone in loud environments, while the directionality decreases, for example, as the environment falls thus preserving the localization capability and the response capability from the rear. The combination of frequency channels for deliberate reduction in the directionality furthermore has the advantage that the design and construction complexity for directional hearing aids can be reduced because more degrees of freedom are available for the arrangement of the microphones and the separation of the microphone and receiver, in order to avoid feedback. Typically, the rearward microphone is more sensitive to mechanical feedback. In the case of adaptive attenuation of the rearward microphone the configuration and manufacturing complexity can be reduced here, since the system is less sensitive to feedback, because of the artificial attenuation.

1. A method for adjusting a directional characteristic of a hearing apparatus, which comprises the steps of:
obtaining a microphone signal having a plurality of frequency bands from an input sound by means of a microphone system having at least two microphones;
determining a characteristic of the microphone signal; and
adjusting a directional characteristic of the microphone system in dependence on the characteristic of the microphone signal, for adjusting the directional characteristic, at least two of the frequency bands are combined in dependence on the characteristic of the microphone signal to form a broader frequency band being combined frequency bands, and a common directional characteristic is in this way provided for the combined frequency bands, the common directional characteristic being slurred in comparison to directional characteristics for the at least two frequency bands, such that a directivity of the common directional characteristic is reduced.

2. The method according to claim 1, wherein the characteristic of the microphone signal includes its level.

3. The method according to claim 2, which further comprises increasing a directionality of the microphone system as the level increases.

4. The method according to claim 1, wherein the characteristic of the microphone signal characterizes at least one predetermined acoustic situations.

5. The method according to claim 1, wherein a number of the combined frequency bands is varied manually, and a current number is learnt by the hearing apparatus, together with a current characteristic of the microphone signal for later automatic adjustment.

6. The method according to claim 1, wherein switching takes place from a static operating mode, in which a number of the combined frequency bands is fixed, to an adaptive operating mode, in which the number of combined frequency bands is automatically matched to a current situation.

7. A hearing apparatus, comprising:
a microphone system containing at least two microphones for obtaining a microphone signal having a plurality of frequency bands, from an input sound;
an analysis device for determining a characteristic of the microphone signal and coupled to said microphone system; and
a processing device for adjusting a directional characteristic of said microphone system in dependence on the characteristic of the microphone signal, and while the directional characteristic is being adjusted, said processing device can combine at least two of the frequency bands in dependence on the characteristic of the microphone signal to form a broader frequency band being combined frequency bands, and can in this way provide a common directional characteristic for the combined frequency bands, the common directional characteristic being slurred in comparison to directional characteristics for the at least two frequency bands, such that a directivity of the common directional characteristic is reduced.

8. A method for adjusting a directional characteristic of a hearing apparatus, which comprises the steps of:
obtaining a microphone signal from an input sound by means of a microphone system having at least two microphones;
determining a characteristic of the microphone signal; and
adjusting the directional characteristic of the microphone system in dependence on the characteristic of the microphone signal, in order to adjust the directional characteristic, the adjusting step performing one of:
attenuating one of the two microphones in dependence on the characteristic of the microphone signal resulting in a directivity of the directional characteristic being reduced; and
mismatching both of the microphones to one another in dependence on the characteristic of the microphone signal resulting in the directivity of the directional characteristic being reduced.

9. The method according to claim 8, which further comprises carrying out the attenuating or the mismatching in dependence on an instantaneous gain in the hearing apparatus.

10. The method according to claim 8, wherein the microphone system has a front microphone and a rear microphone with respect to a predetermined wearing position of the hearing apparatus, and the rear microphone is attenuated.

11. A hearing apparatus, comprising:
a microphone system containing at least two microphones for obtaining a microphone signal from an input sound;
an analysis device for determining a characteristic of the microphone signal and coupled to said microphone system; and
a processing device for adjusting a directional characteristic of said microphone system in dependence on the characteristic of the microphone signal, and while adjusting the directional characteristic, said processing device can attenuate one of said two microphones in dependence on the characteristic of the microphone signal, or both of said microphones are mismatched to one another in dependence on the characteristic of the microphone signal, so as to reduce a directivity of the directional characteristic.
